(19) United States
(12) Patent Application Publication
(10) Pub. No.: US 2010/0094826 A1
(43) Pub. Date: Apr. 15, 2010

(54) SYSTEM FOR RESOLVING ENTITIES IN TEXT INTO REAL WORLD OBJECTS USING CONTEXT

(76) Inventor: Omid Rouhani-Kalleh, Santa Clara, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/251,146

(22) Filed: Oct. 14, 2008

(51) Int. Cl. G06F 17/30; G06Q 30/00

(52) U.S. Cl. 707/705; 705/14.54; 705/14.55

(57) ABSTRACT

A method and apparatus for establishing a degree of confidence that a real world object correctly represents a string is provided. The method includes receiving a string in a context. The string can then be related to a real world object with a degree of confidence based on a click log, link graph, redirect list, or object list. The object can be initially associated with a category or mapped to a category. Then, the degree of confidence can be raised if the category matches the context. If the category does not match the context, the degree of confidence can be lowered. An online service provider using the method can then determine what type of content to send a user based on the confidence level.

### FIELD OF THE INVENTION

The present invention relates to establishing a degree of confidence that an object correctly represents a string. More specifically, the degree of confidence is modified if the object fits within a category that matches a context of the string.

### BACKGROUND

Advertising revenues are a valuable source of income for online service providers such as Web sites. However, users of online services despise advertisements, especially when the advertisements are irrelevant. Online service providers strive to minimize user exposure to irrelevant advertisements and maximize user exposure to relevant advertisements. Further, users are more likely to notice and pursue advertisements when the advertisements show familiar content.

Not only are users becoming less tolerant of irrelevant advertisements, but users also demand more efficient online services. Users appreciate being directed to relevant content while using an online service in much the same way that customers browsing in a department store appreciate being helped by a salesperson and directed to the items the customers actually seek. Unlike customers seeking items in a department store, users of online services often seek information, whether that information relates to a purchase or not. Online service providers cannot afford to hire a salesperson to help every non-paying user. In an effort to increase user satisfaction, online service providers have attempted to find machine-implemented ways to suggest products to users.

Much like department stores, some online service providers try to satisfy all of the user's needs through one portal or interface. For example, Yahoo! Inc., through the URL http://www.yahoo.com, can direct the user to almost any public information or service sought by the user. Users can expect to find anything through all-in-one online service providers such as Yahoo! Inc., so long as users type the correct keywords when searching for information.

Online service providers also attempt to reach users before users begin searching. For example, sometimes online service providers offer feeds to current links corresponding to a user's favorite content categories. To set up these feeds, the user may select favorite categories or favorite teams from a list. The service provider then keeps track of the topics in which the user is interested and updates the user with new content from these topics.

Another approach is to provide suggestions to users based on keywords found in emails, blogs, or notes. In this approach, suggestions are based on content the user is already reading or writing. For example, if the user receives an email or writes a note using the term “pizza,” then advertisements associated with the keyword “pizza” could be provided to the user.

One major problem faced by online service providers is that certain keywords are ambiguous, that is the online service provider cannot determine the real world object to which the keyword relates. For example, in the phrase, “Orange County is a nice flick,” the online service provider would not know if “Orange County” refers to a county or a movie. The online service provider would not be able to determine what type of information to send to the user. The online service provider could send information about traveling to Orange County or about renting “Orange County,” the movie. Given the current techniques used to select advertisements, many online service providers would send users either random advertisements or advertisements for oranges.

Online service providers miss out on countless opportunities to share valuable information with users because either the online service providers cannot determine what type of information to send users, or the online service providers send the wrong information to users. Online service providers have been making blind decisions about ambiguous terms. As such, an online service provider misleads the user when the wrong meaning is chosen for an ambiguous term. In the “Orange County” example, the online service provider might mistakenly send information about traveling to Orange County when the user was typing about watching the movie, “Orange County.”

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram illustrating one system for resolving an entity into a real world object with a degree of confidence.

FIG. 2 is a diagram illustrating one system for sending content to a user based on a category with a degree of confidence.

FIG. 3 is a decision tree representing one strategy for determining whether to send content once a category and degree of confidence are provided.

FIG. 4 is a block diagram that illustrates a computer system that can be used to resolve an entity into a real world object with a degree of confidence.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

A method is described for predicting to which real world object a keyword refers. A keyword is selected from a portion of text. The keyword is categorized into a context category based on a context of the keyword in a portion of text. The keyword is also categorized into an object category based on known real world objects to which the keyword could refer. The object category can then be compared to the context category to determine a degree of confidence for whether the keyword in the context refers to one of the known real world objects. If the object category matches the context category, then the degree of confidence can be raised. If the object category does not match the context category, then the degree of confidence can be lowered. The degree of confidence can be used to determine what content to send to a user who typed the portion of text. The method may be performed on one central machine or on several machines each with several processors.

The elements of the method are named to aid in discussion of example systems using the method. However, the underlying method can be performed even if the elements are combined, distributed, or given different names. The method may be applied on a variety of platforms, using a variety of formats, a variety of data structures, and a variety of devices.

### Exemplary System Resolving Unambiguous Keyword

One way for online service provider to provide content-specific advertisements to a user involves selecting advertisements based on keywords, or strings of characters, found in the user's emails, blogs, or notes. This method can be called the keyword technique. Some keywords refer to only a single object, but some keywords can refer to multiple objects. Keywords that refer to only one object are called unambiguous keywords because the keyword technique alone can reliably identify to what the keyword refers. Based on an unambiguous keyword, the online service provider can choose content to send to the user. For example, if the user types, “I like to eat pizza,” in an email, then the online service provider could send the user content (e.g., advertisements) associated with the keyword, “pizza.” The content can be any advertisement that falls under a keyword category, “pizza.” The content may be in the form of an advertisement for pizza delivery services, or information about making a pizza at home. The keyword technique alone cannot reliably identify to what object the user is referring when the keyword is ambiguous.

### Ambiguities from Keywords

Ambiguous keywords can have more than one possible meaning. One example of an ambiguous keyword is “Orange County.” An online service provider using the keyword technique cannot disambiguate keywords like “Orange County.” Disambiguation is the process of resolving an ambiguity of meaning. One way to disambiguate “Orange County” is to ask the user to which Orange County he or she was referring. Obviously, online service providers do not have enough time or money to poll the user before each advertisement.

Another way to resolve ambiguous keywords involves determining the intended meaning of the keyword based on the context of the keyword. The context of the keyword is determined based on the portion of text surrounding the keyword. In the example involving the keyword, “Orange County,” in the portion of text, “Orange County is a nice flick,” the keyword category, “Movie,” is generated from a word in the portion of text, “flick.” Based on the context, the sentence structure, or the distance between words, the keyword category has a degree of confidence that the keyword category describes the keyword in context. In the example, a connecting word, “is,” appears in the same sentence, or larger text, with the two words, “Orange County” and “flick.” Further, the connecting word, “is,” appears between the two words. The degree of confidence in the keyword category “Movie” can be higher because two words connected by the connecting word, “is,” are usually similar.

The intended meaning of a keyword cannot always be determined based on the keyword's context. Due to the complexity of language, the context of a keyword can be difficult for a machine to determine. Also, the user may not always provide an unambiguous context. In the example, “Orange County is a nice flick,” the degree of confidence may be lower due to the weak link between the word, “flick,” and the keyword category, “Movie.” The word, “flick,” is ambiguous because the word, “flick,” can be used in more than one way, such as “the flick of a whip.” If the user typed the word, “motion picture,” near the keyword, “Orange County,” then the degree of confidence can be higher because “motion picture” is not ambiguous.

The context may also be ambiguous when words from varying categories appear near the keyword. For example, “the jaguar convertible is a beast,” can appear with the keyword “jaguar.” Each of the words, “convertible” and “beast,” can be associated with a different category. The word, “convertible,” can be associated with an automobile, and the word, “beast,” can be associated with a cat. If the factors are otherwise equal, then an equal degree of confidence can be assigned to each category to maximize entropy. For example, the word, “convertible,” can be associated to the “Automobile” category with a 0.5 degree of confidence, and the word, “beast,” can be associated with the “Cat” category with a 0.5 degree of confidence. Methods for keyword detection and classification, including a method for keyword classification using maximum entropy, are explained in more detail by Nigam, K., Lafferty, J. & McCallum, A., “Using Maximum Entropy for Text Classification,” Published by IJCAI-99 Workshop: Machine Learning for Information Filtering, Stockholm, Sweden, Europe (August 1999), which is incorporated herein in its entirety.

Certain keywords may be ambiguous even with descriptive, unambiguous context. For example, “Romeo and Juliet is a nice movie,” is ambiguous even though the surrounding text is descriptive. The keyword, “Romeo and Juliet,” can refer to tens or possibly hundreds of different movies.

### Exemplary System Resolving Ambiguous Keyword

A more efficient way to resolve ambiguous keywords involves using the keyword to generate a list of objects to which the keyword could refer, each object in the list having a degree of confidence that the keyword refers to that object. The degree of confidence is based on the frequency by which users use the keyword to refer to the object. The object is mapped to an object category based on the content of the object. The object category is compared to the possible keyword categories to determine whether the object fits with the keyword as the keyword is used in the portion of text. If the object category matches the keyword category, then the online service provider can be more confident that the object represents the intended meaning of the keyword as typed by the user.

### Mapping Keyword to Object

In the “Orange County” example, the keyword “Orange County” is then associated with objects based upon a statistical analysis of the keyword's ordinary use. The statistical analysis is based on search engine click logs, link graphs using anchor text, editorially managed redirect lists, and/or a list of objects. For example, “Orange County” can be associated with the objects, “Orange_County,_California” and “Orange_County_(film)”. In one embodiment, object names are the names of Wikipedia® pages. Each Wikipedia® page has a name that corresponds to a unique Wikipedia® entry. In the “Orange County” example, the Wikipedia® page name “Orange_County,_California” is associated with a Wikipedia® page about Orange County, Calif. Wikipedia® is a registered trademark of the Wikimedia Foundation, Inc. More will be discussed later about the advantages of using Wikipedia®.

In one embodiment, the objects, “Orange_County,_California” and “Orange_County_(film),” are predicted with some degree of confidence based on a statistical analysis from click logs for “Orange County,” link graphs using anchor text “Orange County,” redirect lists for “Orange County,” disambiguation lists for “Orange County,” and lists of objects named “*Orange*County*,” where * represents a wildcard placeholder. Example degrees of confidence are 0.85 for the object, “Orange_County,_California,” and 0.15 for the object, “Orange_County_(film),” indicating that the online service provider can be more confident that the string represents the object, “Orange_County,_California,” than the object, “Orange_County_(film).”

### Categorizing Objects

In the “Orange County” example, the two objects, “Orange_County,_California” and “Orange_County_(film),” are then used to look up categories for those objects. In one embodiment, Wikipedia® is used to find categories for the objects. Wikipedia® allows users to create categories manually when new Wikipedia® pages are created or modified. Wikipedia® makes categories available in a SQL (Structured Query Language) database. Due to the lack of conformity in Wikipedia® category names, a more reliable source of Wikipedia® object categories is preferred.

In another embodiment, the YAGO (Yet Another Great Ontology) ontology can be used to classify objects into categories. The YAGO ontology relates Wikipedia® entries, which can be objects, to WordNet® synsets. A synset is a set of words with the same sense, or meaning. WordNet® is a database of English words and their associated definitions. The YAGO ontology, and the creation of, use of, and maintenance of the YAGO ontology, is explained in more detail by Suchanek, F. M., Kasneci, G. & Weikum, G., “YAGO: A Core of Semantic Knowledge—Unifying WordNet and Wikipedia®,” The 16th International World Wide Web Conference, Semantic Web: Ontologies Published by the Max Planck Institut Informatik, Saarbrucken, Germany, Europe (May 2007) which is incorporated herein in its entirety. More will be discussed later about the advantages of using the YAGO ontology.

In one embodiment using the “Orange County” example, the two objects, “Orange_County,_California” and “Orange_County_(film),” are queried in the YAGO ontology. An input with object, “Orange_County,_California,” if identified as a county by YAGO, would cause the categories “County” and/or “Place” to be returned. Similarly, an input with object, “Orange_County_(film),” if identified as a motion picture film by YAGO, would cause the categories “Film” and/or “MotionPictureFilm” to be returned. The categories associated with the objects can be called the object categories.

### Matching Object Category to Keyword Category

In one embodiment, the object categories are then associated with the keyword categories. In the “Orange County” example, “Movie” is the keyword category. In one embodiment, the keyword category is associated to many object categories. A table associating keyword categories to object categories is created by manually mapping the keyword categories to the object categories. In an alternate embodiment, a thesaurus or other list of related categories connects synonymous categories. In the “Orange County” example, the object categories, “County” and/or “Place,” for the object, “Orange_County,_California,” are not found under the keyword category “Movie” because the object categories are not similar to “Movie.” However, the object categories, “Film” and/or “MotionPictureFilm,” for the object, “Orange_County_(film),” are found under the keyword category “Movie” because the object categories are synonymous with the term “Movie.”

### Modifying Degree of Confidence

Because the keyword category for “Orange County” matches the object category for the object, “Orange_County_(film),” the online service provider has a higher degree of confidence that the keyword is correctly represented by the object, “Orange_County_(film).” Conversely, because the keyword category for “Orange County” did not match any of the object categories for the object, “Orange_County,_California,” the online service provider has a lower degree of confidence that the keyword is correctly represented by the object, “Orange_County,_California.” In the “Orange County” example, the degrees of confidence could be modified from 0.15 to 0.95 for the object, “Orange_County_(film),” and from 0.85 to 0.05 for the object, “Orange_County,_California.” After modification, the degree of confidence is called the new, modified, or associated degree of confidence.

### Using the Modified Degree of Confidence

The modified degree of confidence is then used to determine whether to display content to the user, and, if so, which content to display. In the “Orange County” example, the service provider displays information about renting “Orange County,” the film. A database of advertisements are categorized so that an advertisement associated with the object category, the object itself, the keyword category, or the keyword can be selected. For example, in one embodiment, a database for Amazon.com, a large online retailer, generates an advertisement for a movie or motion picture film sold on Amazon.com, more specifically a movie entitled “Orange County,” or most specifically the movie associated with Wikipedia® page name, “Orange_County_(film),” which was released in 2002.

In the “Orange County” example, the online service provider then sends the appropriate content-specific advertisement to the user so that the user can purchase related goods or services, or find related information.

### Exemplary Entity-to-Object Resolution System Detecting Keyword

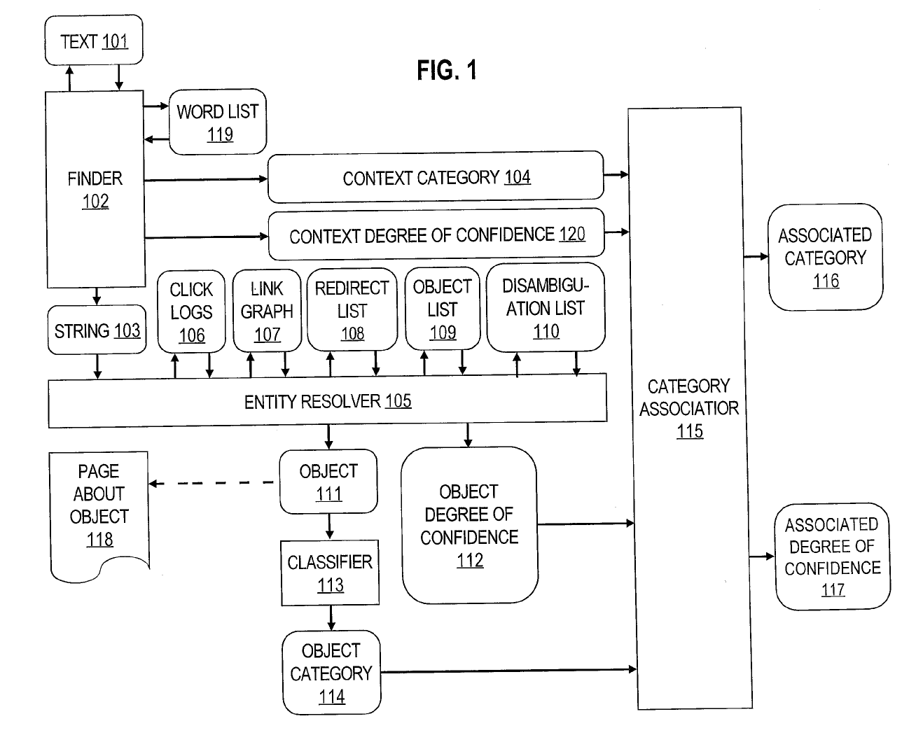

FIG. 1 is a detailed diagram illustrating one system for resolving an entity into a real world object with a degree of confidence. Finder 102 finds an entity, keyword, or string 103 in text 101. Finder 102 detects string 103 in text 101 by searching for portions of text 101 in word list 119. Alternatively, finder 102 detects string 103 in text 101 by searching for members of word list 119 in text 101. In another embodiment, finder 102 is provided with string 103 and text 101 associated with string 103.

Text 101 is a document, blog, email, note, Web page, or any other collection of characters. Word list 119 is any kind of dictionary or word list, such as an online dictionary or a dictionary stored in memory. In one embodiment, word list 119 is a list of categorized words.

### Categorizing String Based on Context

Each string 103 can either be found or not found in word list 119. If string 103 cannot be found in word list 119, then string 103 is categorized based on text 101. If string 103 can be found in word list 119, then string 103 is categorized based on both text 101 and string 103. String 103 is categorized based on the category or categories associated with string 103 in word list 119.

For each string 103, a sample number of words before and after the string, perhaps ten words before and ten words after for a total of twenty-one words, are categorized. Finder 102 searches for each of the sample number of words in word list 119. If a word from the sample number of words can be found in word list 119, then the word is categorized based on a category associated with the word in word list 119.

The words in the sample number of words can also be categorized using a system such as WordNet®, which provides a synset for each word. In one embodiment, word list 119 is a list of synsets from WordNet®. Synsets, or meanings, can be related to other synsets through relations such as hypernymy and hyponymy. A hypernym is a species of a broader synset, and a hyponym is a class of a narrower synset. Finder 102 classifies each word as a synset based on the WordNet® synset associated with the word. In one embodiment, associating a word with a synset also causes the word to be associated with a hyponym of that synset.

Once string 103 and the sample of words from text 101 have been categorized, finder 102 predicts a category or list of categories that string 103 could be associated with. Finder 102 predicts context category 104 based on string 103 and/or the categories of the sample of words from text 101. Context category 104 has a context degree of confidence 120 representing how confident finder 102 can be that context category 104 represents string 103. If finder 102 finds a list of categories with which string 103 could be associated, then each context category 104 has context degree of confidence 120, in one embodiment.

### Resolving Entity into Object

Finder 102 then passes string 103 to entity resolver 105. Entity resolver 105 can resolve string 103 into an object 111. To resolve string 103 into object 111, entity resolver 105 uses any source of a group of sources including: click logs 106, link graph 107, redirect list 108, and object list 109. Each source from the group of sources associates string 103 to object 111 with object degree of confidence 112. If entity resolver 105 uses the object 111 and object degree of confidence 112 from more than one source from the group of sources, then entity resolver 105 can weigh each source and combine the objects and object degrees of confidence into a combined list of objects and object degrees of confidence. Entity resolver 105 can also, optionally, use object 111 and degree of confidence 112 from only one source.

### Determining Object and Degree of Confidence

Click logs 106 show on which objects users have clicked when searching for or using string 103. In one embodiment, click logs 106 are based on a popular search engine. A collection of searches using string 103 are logged on the search engine to determine which link users normally follow. In the “Orange County” example, users who normally search for “Orange County” could navigate to the page associated with Wikipedia® identifier, “Orange_County,_California,” 14% of the time and the page associated with Wikipedia® identifier, “Orange_County_(film),” 5% of the time. Click logs 106 then show the “Orange_County,_California” object with an object degree of confidence of 0.14 and the “Orange_County_(film)” object with an object degree of confidence of 0.05.

Link graph 107 shows to which objects anchor text containing string 103 most often points. Search engines use link graphs to rank pages. Pages that are linked to more often by other pages receive a higher rank. Link graph 107 shows which pages receive the most links from anchor text matching string 103. In the “Orange County” example, links with the anchor text “Orange County” could link to Wikipedia® page, “Orange_County,_California,” 20% of the time and Wikipedia® page, “Orange_County_(film)” 12% of the time. Link graph 107 then shows the “Orange_County,_California” object with an object degree of confidence of 0.20 and the “Orange_County_(film)” object with an object degree of confidence of 0.12.

Redirect list 108 associates string 103 with an object that has been selected to be associated with the string 103. Many organized sites have redirect lists that direct a user to a target object, or target page, from another page. Redirect lists 108 are managed by sites and updated frequently. If the user navigates to the page, “Orange_County_(movie),” redirect list 108 redirects the user to the object, “Orange_County_(film).” The Wikipedia® site has editorially managed redirect lists for commonly used strings. A Wikipedia® user or staff editor may update the redirect list 108 when the user wants one page to be redirected to another page. In the “Orange County” example, the redirect list 108 for pages directed to the object, “Orange_County,_California” includes “Orange_County,_CA,” and “Orange County, California,” where the space character is represented by “%20” in a URL (“Orange%20County,%20California”). Redirect list 108 would return the “Orange_County,_California” object in response to an input of “Orange_County,_CA,” or “Orange County, California.”

Disambiguation list 110 associates string 103 with objects that have been selected to be associated with string 103. Web sites may have disambiguation lists to direct a user to a page when the user has typed in an ambiguous search phrase. Disambiguation lists are managed by users or staff by manually ordering a list of objects to which string 103 can refer. If the user types in, “Orange County,” disambiguation list 110 provides the user with the option to navigate to any one of a number of matching pages. In the “Orange County” example, the disambiguation list 110 for string 103, “Orange County” may list Wikipedia® page, “Orange_County,_California” first and Wikipedia® page, “Orange_County_(film)” third. Disambiguation list 110 may then show the “Orange_County,_California” object with a higher object degree of confidence than the “Orange_County_(film)” object.

Object list 109 associates string 103 with the name of objects. In one embodiment, object list 109 can handle wildcard placeholders such as “*” to match string 103 with objects having similar names. In the “Orange County” example, wildcard placeholders are placed before and after “Orange County” and in spaces between the words “Orange” and “County.” Entity resolver 105 sends “*Orange*County*” to object list 109. Object list 109 searches for a objects with “Orange” before “County” and returns the “Orange_County,_California” object and the “Orange_County_(film)” object with similar object degrees of confidence.

### Object

In one embodiment, each object 111 points to a page 118 about the object. In a further embodiment, page 118 about the object is a Wikipedia® page, accessible through a URL (Uniform Resource Locator). Additionally, the entire library of Wikipedia® pages is downloadable for faster and more reliable access.

Many advantages can come from using objects that point to Wikipedia® pages, some of which have already been discussed. Wikipedia® is a free user-generated online encyclopedia, and Wikipedia® content is managed and edited by Wikipedia® staff or by users of Wikipedia®. Further, Wikipedia® has grown tremendously since 2001, when the Wikipedia® site was born. According to Wikipedia®, the site had over 10 million articles in April of 2008. Users who search for information on the Web often end their search on a Wikipedia® page. Finally, the breadth of editing and discussion by users makes Wikipedia® content more reliable than other sources of content.

### Categorizing Object

In one embodiment, entity resolver 105 sends object 111 to a classifier 113. Entity resolver 105 sends object degree of confidence 112 to category associator 115. Classifier 113 categorizes object 111 into an object category 114. Object 111 can initially be associated with many categories. Also, an object can be mapped to new categories based on the object's content.

The YAGO ontology can be used to map object 111 to object category 114. The YAGO ontology is accessible through a URL. Additionally, the YAGO ontology can be downloaded for faster and more reliable access.

Many advantages can come from using the YAGO ontology. The YAGO ontology is a system already in place to categorize Wikipedia® pages. As previously discussed, a technique for making, using, and maintaining the YAGO ontology is disclosed in Suchanek, et al., “YAGO: A Core of Semantic Knowledge—Unifying WordNet and Wikipedia®.” However, due to the breadth of information presented on Wikipedia®, the task of categorizing Wikipedia® pages, although disclosed by Suchanek, is time consuming to implement. Other methods of categorizing Wikipedia® pages are optionally used, but the YAGO ontology represents a good system already in place to perform such a task.

### Associating Object Category with Context Category

Classifier 113 sends object category 114 to category associator 115. Category associator 115 then determines whether object category 114 is similar to context category 104. If object category 114 is mapped to context category 104, then category associator 115 raises object degree of confidence 112 to generate an associated degree of confidence 117. If object category 114 is not mapped to context category 104, then category associator 115 lowers object degree of confidence 112 to generate associated degree of confidence 117.

In one embodiment, category associator 115 also uses context degree of confidence 120 when determining how much to modify object degree of confidence 117. If context degree of confidence 120 is low, then object degree of confidence 117 can be modified a small amount. If context degree of confidence 120 is high, then object degree of confidence 117 can be modified a large amount.

Object category 114 may be associated with context category 104 in a number of ways. In one embodiment, the online service provider manually associates object category 114 with context category 104. Then, the online service provider stores object category 114 under context category 104 in a table for later lookup. In one embodiment, a thesaurus is used to associate object category 114 with context category 104. Category associator 115 determines using any method of association whether or not object category 114 is associated with context category 104.

The category associator stores associated degree of confidence 117 and associated category 116. In one embodiment, associated degree of confidence 117 is stored as a number or decimal, such as “0.95” or 95. Associated degree of confidence 117 can be stored in any way so long as associated degree of confidence 117 is used to determine the level of confidence to which the online service provider predicts whether object 111 correctly represents string 103.

In one embodiment, associated category 116 is any of: object category 114, object 111, context category 104, and/or string 103. If associated category 116 is object category 114, then the online service provider determines which content to send based on which category object 111 falls under. If object category 114 does not match context category 104, then the online service provider may want to use context category 104 to determine which content to send based on the context that string 103 falls under. If the online service provider has content about specific objects, then the online service provider may want to use object 111 to determine whether to send object-specific content. If the online service provider has content about specific strings, then the online service provider may want to use string 103 to determine whether to send string-specific content. However, using string-specific content without information about object 111 does not allow the online service provider to disambiguate string 103.

### Exemplary System Showing Content-Specific Ads

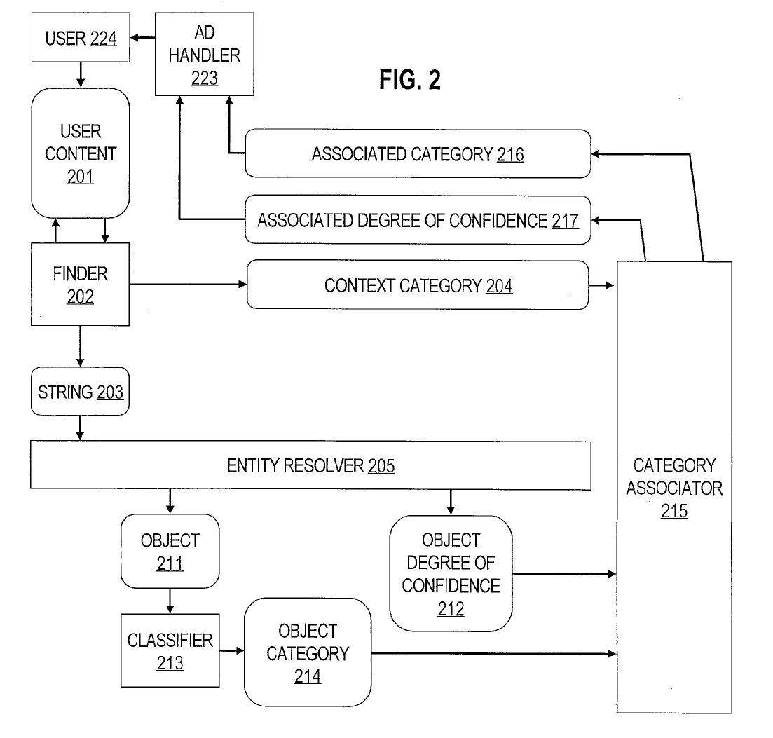

FIG. 2 is a diagram showing one way that an ad handler 223 can be used to send to a user content that is based on a category with a degree of confidence. In FIG. 2, a user 224 generates user content 201 that is sent to finder 202. Finder 202 detects a string 203 within user content 201 and associates a context category 204 with string 203.

Finder 202 then sends string 203 to an entity resolver 205. Entity resolver 205 resolves string 203 into an object 211 with an object degree of confidence 212. A classifier 213 then classifies object 211 into an object category 214. Classifier 213 sends object category 214 to a category associator 215.

Category associator 215 receives context category 204 from finder 202, object category 214 from classifier 213, and object degree of confidence 212 from entity resolver 205. Category associator 215 determines whether object category 214 matches with or is associated with context category 204. If the categories match, then category associator 215 raises object degree of confidence 212 to produce an associated degree of confidence 217. If the categories do not match, then category associator 215 lowers object degree of confidence 212 to produce associated degree of confidence 217.

Associated category 216 represents any of object category 214, context category 204, object 211, or string 203. In one embodiment, the associated category 216 represents object categories 214 that match context categories 204. In another embodiment, associated category 216 is the same as object category 214. In one embodiment, category associator 215 eliminates a nonmatching object category 214 when producing associated category 216.

An ad handler 223 receives associated category 216 and associated degree of confidence 217 from category associator 215. Ad handler 223 then determines which content to send to user 224 based on associated category 216 and associated degree of confidence 217. If associated degree of confidence 217 is higher than a threshold amount for certain associated category 216, then ad handler 223 selects an ad that matches associated category 216. If associated degree of confidence 217 is low for certain associated category 216, then ad handler 223 chooses not to advertise, sends a random advertisement, or selects an ad that matches a different object category.

### Exemplary Decision Process for Displaying Ads

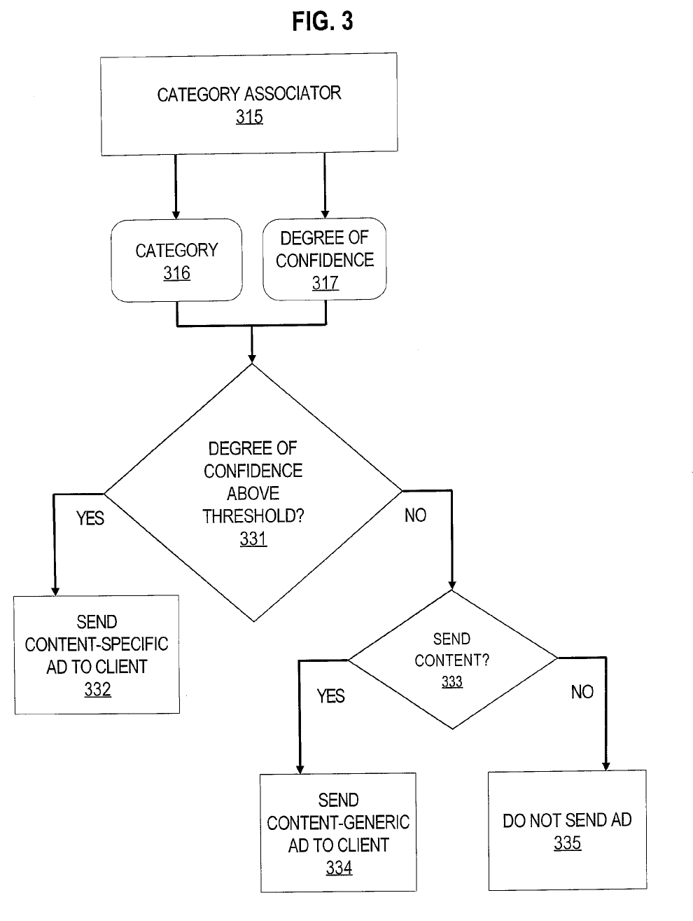

FIG. 3 is a decision tree representing one strategy for determining whether to send content once a category and degree of confidence are provided. Category associator 315 provides a category 316 with an associated degree of confidence 317. In one embodiment to determine whether to display content to the user, the online service provider can look at degree of confidence 317 to determine if degree of confidence 317 is above a threshold amount in step 331. In one example, the threshold amount is 0.5, requiring that degree of confidence 317 be at least 50%. If degree of confidence 317 is above the threshold amount, then the online service provider sends a content-specific ad to the user in step 332.

If degree of confidence 317 is below the threshold amount, then the online service provider decides whether to send content to the user in step 333. If the online service provider still wishes to send content, then the online service provider sends a content-generic ad to the user in step 334. If the online service provider no longer wishes to send content, then the online service provider selects not to send content to the user in step 335.

### Hardware Overview

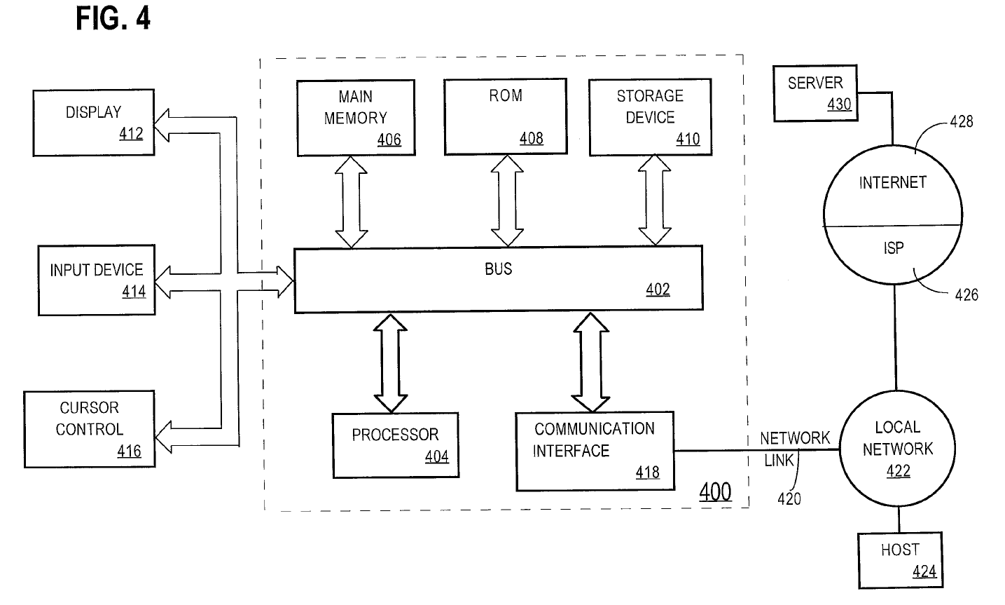

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving a string that is related to a first category;
determining an object that represents the string to a degree of confidence;
mapping the object to a second category;
associating the first category and the second category; and
based on said associating, modifying and storing the degree of confidence on a volatile or non-volatile computer-readable storage medium.

2. The method of claim 1 wherein said receiving comprises selecting the string from a text.

3. The method of claim 2 wherein said selecting comprises selecting the string that matches a word list entry.

4. The method of claim 3 wherein said relatedness between the first category and the string is based on the word list entry.

5. The method of claim 2 wherein said relatedness between the first category and the string is based on a word list entry that matches a second string in the text.

6. The method of claim 4 wherein said word list entry comprises a word with an associated synset.

7. The method of claim 1, further comprising determining a second degree of confidence for said relatedness between the first category and the string, and wherein said modifying the degree of confidence comprises using the second degree of confidence to determine how much to modify the degree of confidence.

8. The method of claim 1 wherein said representing the string comprises identifying an informational page associated with a meaning of the string.

9. The method of claim 1 wherein said determining comprises determining the object from search engine click logs based on the string.

10. The method of claim 1 wherein said determining comprises determining the object from a link graph based on the string.

11. The method of claim 1 wherein said determining comprises determining the object from an editorially managed redirect list based on the string.

12. The method of claim 1 wherein said determining comprises determining the object from a disambiguation list based on the string.

13. The method of claim 8 wherein said determining comprises determining the object that matches a name for the page.

14. The method of claim 1 wherein said determining comprises determining the object by weighing sources selected from the group consisting of:
search engine click logs based on the string;
a link graph using the string;
an editorially managed redirect list based on the string;
a disambiguation list based on the string; and
a unique identifier matching the string.

15. The method of claim 1 further comprising determining whether the degree of confidence is higher than a threshold level, and sending content related to the second category when the degree of confidence is higher than the threshold level.

16. The method of claim 15 wherein the content is an advertisement related to the object.

17. A volatile or non-volatile computer-readable storage medium carrying one or more sequences of instructions, wherein execution of the one or more sequences of instructions by one or more processors causes the one or more processors to perform the steps of:
receiving a string that is related to a first category;
determining an object that represents the string to a degree of confidence;
mapping the object to a second category;
associating the first category and the second category; and
based on said associating, modifying the degree of confidence.

18. The volatile or non-volatile computer-readable storage medium of claim 17 wherein said receiving comprises selecting the string from a text.

19. The volatile or non-volatile computer-readable storage medium of claim 18 wherein said selecting comprises selecting the string that matches a word list entry.

20. The volatile or non-volatile computer-readable storage medium of claim 19 wherein said relatedness between the first category and the string is based on the word list entry.

21. The volatile or non-volatile computer-readable storage medium of claim 18 wherein said relatedness between the first category and the string is based on a word list entry that matches a second string in the text.

22. The volatile or non-volatile computer-readable storage medium of claim 20 wherein said word list entry comprises a word with an associated synset.

23. The volatile or non-volatile computer-readable storage medium of claim 17, wherein the steps further comprise determining a second degree of confidence for said relatedness between the first category and the string, and wherein said modifying the degree of confidence comprises using the second degree of confidence to determine how much to modify the degree of confidence.

24. The volatile or non-volatile computer-readable storage medium of claim 17 wherein representing the string comprises identifying an informational page associated with a meaning of the string.

25. The volatile or non-volatile computer-readable storage medium of claim 17 wherein said determining comprises determining the object from search engine click logs based on the string.

26. The volatile or non-volatile computer-readable storage medium of claim 17 wherein said determining comprises determining the object from a link graph based on the string.

27. The volatile or non-volatile computer-readable storage medium of claim 17 wherein said determining comprises determining the object from an editorially managed redirect list based on the string.

28. The volatile or non-volatile computer-readable storage medium of claim 17 wherein said determining comprises determining the object from a disambiguation list based on the string.

29. The volatile or non-volatile computer-readable storage medium of claim 24 wherein said determining comprises determining the object that matches a name for the page.

30. The volatile or non-volatile computer-readable storage medium of claim 17 wherein said determining comprises determining the object by weighing sources selected from the group consisting of:
search engine click logs based on the string;
a link graph using the string;
an editorially managed redirect list based on the string;
a disambiguation list based on the string; and
a unique identifier matching the string.

31. The volatile or non-volatile computer-readable storage medium of claim 17 the steps further comprising determining whether the degree of confidence is higher than a threshold level, and sending content related to the second category when the degree of confidence is higher than the threshold level.

32. The volatile or non-volatile computer-readable storage medium of claim 31 wherein the content is an advertisement related to the object.
